(19) United States
(12) Patent Application Publication
(10) Pub. No.: US 2017/0342696 A1
(43) Pub. Date: Nov. 30, 2017

(54) JET BIDET

(71) Applicant: Valentin Aleksandrovich CHIRKOV, Moscow (RU)

(72) Inventor: Valentin Aleksandrovich CHIRKOV, Moscow (RU)

(21) Appl. No.: 15/525,293

(22) PCT Filed: Mar. 18, 2016
(86) PCT No.: PCT/RU2016/000151

§ 371 Date: May 9, 2017

(30) Foreign Application Priority Data
Jun. 16, 2015 (RU) 2015122937

(51) Int. Cl. E03D 9/08; A61H 35/00

(52) U.S. Cl. CPC E03D 9/08; A61H 35/00

(57) ABSTRACT

A jet bidet for use for washing the private parts of a person who is sitting thereon merely having lowered their lower garments, without having to strip naked. The bidet basin has the configuration and dimensions of a standard toilet which is somewhat elongated such that a user's hand can pass between the legs at the front and behind the user's back at the rear. A spray nozzle producing a rising water jet is placed in the basin. The spray nozzle is focused upon the private parts to be washed of the user's body. The bidet basin is fitted with a drainage outlet and is equipped with an overflow prevention device. A lever mixer of hot and cold water is located at the front and is handily positioned between the knees of the user sitting on the basin.

The present disclosure relates to the class of devices intended for washing individual parts of the human body for special therapeutic or hygienic purposes with means to spray water upwards. Known from the prior art are bidets containing means for spraying water upwards, which bidets are an attempt of a modernization of a toilet by adding thereto various devices which make it possible to wash the private parts. These are called integrated bidet and toilet systems. Such a modernization basically comprises the attachment, to the tip-up seat of the toilet, of a water sprayer or a separate shower head on a flexible hose with mixers secured to a wall next to the toilet or to the toilet itself. In this regard, in Russian patent No. 2123561 titled “Bidet”, a shaft of a tip-up seat is used as a water feeding tube. This shaft tube is connected with water feeding hoses of a mixer, and has a water sprayer arranged thereon. Russian patent No. 2138360 discloses the use of a detachable seat that is arranged on a toilet and has a sprayer attached thereto. In Russian patent No. 2075575 RU discloses a similar system which is connected to a toilet through a slot in a tip-up seat while a sprayer tube is of an arched shape and, in its non-operating state, is pushed to the periphery of the toilet bowl. A mixer is arranged beyond the toilet, and its position may be height-adjusted for the convenience of use. Russian patent No. 2111318 discloses a design in which a sprayer is made in the form of an arched tube whose curvature follows that of a toilet bottom; said arched tube may turn about the horizontal axis to wash body parts at various angles. Feeding is accomplished from a standalong peripheral unit which comprises a water mixer, a device for heating and feeding compressed air to the same water sprayer for drying after going through the procedure. The water sprayer is turned by a lever attached to the outside of the toilet body, and water and air are fed from the peripheral unit through a hose provided with a seal.

An engineering analysis of the above designs shows that the attempts to provide a device in which elimination is combined with a subsequent washing procedure result in designs which are complicated to manufacture and install and are inconvenient in practical use.

Currently, dozens of bidet models of a standard design of both standalong type and add-on type are presented in the plumbing fixture market. All of these comprise substantially ceramic bathtubs comprising a waste outlet located at the bathtub bottom, a bathtub overflow protection system with an opening at a rear wall of the bathtub which outlet and system are connected through a trap to a sewerage system and a hot and cold water supply system.

As an exemplary standard model which comprises the above listed components and is equipped additionally with a hinged cover on which a person may sit as on a chair, reference may be made to the Roca Victoria floor-mounted bidet provided with a level mixer with a ball mechanism. http://santehnica-online/ru/product/bide_napolnoe_roca_Victoria_357390000

The disadvantages of the standard models include the inconvenience that, in the beginning of the procedure, one has to sit on or touch a cold ceramic surface of the bathtub, since bathtub heating is not provided for in the standard models and the bathtub should be filled preliminarily with hot water to warm up the same. In a non-standard bidet model, a variant whereof is presented in advertisements, this disadvantage is eliminated but at the cost of a significant complexity in the design: for heating, a sprayer producing a small fountain directed vertically upwards and watering the bathtub walls is installed additionally at the center of the bathtub. One more mixer is installed specially to control the fountain. The non-standard bidet model is more comfortable in use. A handle is provided at the back on a bathtub panel to which all the controls are outputted, and, with the help of this handle, a mechanism which allows closing and opening the waste outlet for filling and emptying the bathtub is actuated. http://vannadecor.ru/kak-polzovatsya-bide-osnovi-osnov#hl-vidy-predlagaemykh-bide, http://www.homeplumber.ru/ustan/article4.shtml.

It is obvious that the non-standard bidet is significantly more comfortable than the simple model. The disadvantages include a structural complexity and the complexity of control because of the employment of two mixers and the mechanism to control the waste outlet. The main disadvantage of both standard bidets and non-standard bidets may be seen not in their structural features but rather in the peculiarities of use meaning that a person has to be practically naked, without clothes, because in order to go through the procedure, the person should be over the bathtub in a half-knee-bend position. In private life, this is acceptable, since each person is like this at least twice a day—before going to sleep and after getting out of bed. In other cases, a problem occurs associated with the removal of clothes, trousers, panti-tights, and the like.
The last of the above bidet designs was taken by the inventor as the prototype.

The task to be solved by the technical solution claimed is to increase the applicability of technical means known in the art and provide a technical device to be connected to hot and cold water supply systems and to a sewerage which would satisfy the technical requirements arising from the interpretation and translation to the technical language of the content of the consumer formula: “A bidet is a toilet companion.” Hence, the basic requirements for the construction of a bidet are the possibility for a user to go through a hygienic washing in the same posture and with the same position of the clothes as when using a toilet, and to have a possibility of performing the hygienic procedure without the use of hands.

The set task is solved on account that a user positions himself/herself on the bidet bathtub in the sitting position being over a part of the tub and thus can use an upward shower jet focused on a part of his/her body to be washed; in doing so, the possibility is eliminated of accidentally sprinkling the user with this jet; a bidet body has two sections connected integrally to supporting and decorative elements, which enable the bidet to be installed on the floor or to be secured to a wall, and comprises a flat boss at the upper portion thereof to which a tip-up seat is attached which covers both bidet sections, and is provided with an elastic seal which prevents water from entering under the seat alone the outline, the bathtub being one of the sections and being made with the shape and size of a standard toilet, somewhat elongated to allow the passage of hands in front between the user's legs and behind his/her back, the bathtub being equipped with a nozzle which produces an upward shower jet whose temperature and pressure are controlled quickly and effectively by the user himself/herself and which is configured with respect to the cross section of the entire jet and small jets it comprises, and is focused on washing a user's body part so as to ensure both comfortable and effective performance of a hygienic procedure without the assistance of hands, the bathtub being provided with a waste outlet at the bathtub bottom in communication with a bathtub overflow protection device arranged at a front wall outside the bathtub, a control compartment being the second section, the control compartment having the shape of an isosceles triangle with a rounded apex whose base is abutting integrally the bathtub at the front thereof, the control compartment being between the knees of the user, who sits on the bathtub, the control compartment being provided with a cold and hot water lever mixer whose outlet is interlocked with a closure device which is controlled by a pressure-action plunger which is arranged under an edge of the tip-up seat being lowered and switches the nozzle on when the user sits down on the seat and switches the nozzle off when the user gets up off the seat; the nozzle may also be switched on by pressing the plunger manually, for example, to fill the bathtub whenever necessary, mnemonic color symbols being applied to a rounded portion of the seat, which covers the control, said symbols indicating the extreme positions of the mixer lever: the cold water position and the hot water position, the warm water position and, for a comfortable beginning of the procedure, the neutral position of the mixer lever.

The technical result ensured by the above-mentioned combination of features comprises increasing the comfort of performing the procedure, its comfortable beginning, since the position of the mixer lever for feeding warm jet is indicated, a comfortable position of a user when sitting; there is no need for but it is possible to use hands when performing a hygienic procedure; discomfort when a person touches a “cold” surface of a ceramic tub with his/her body is eliminated by using a tip-up seat; the risk that an operating nozzle will spatter a user when he/she stands up from the seat accidently; the comfort when using the sanitary ware is increased since it is directly between the legs of a user.

The bidet comprises a two-section body 1 consisting of a bathtub 2 and a control compartment 3, wherein a flat boss 4 integrated with the body is provided at the upper portion of the body, at the back thereof; a tip-up seat 5 is attached to the boss, said seat being provided with an elastic seal 6; a nozzle 7, and a waste outlet 8 that communicates with a bathtub overflow protection device 9 are arranged in the bathtub; a lever mixer 10 that is interlocked with a closure device 11 controlled by a pressure-action plunger 12 is arranged in the control compartment; a rounded portion 13 of the seat is provided with mnemonic color symbols in radial directions of a mixer lever 14, said symbols indicating the extreme positions thereof: the hot water position 15, the cold water position 16, the warm water position 17, and the neutral position 18.

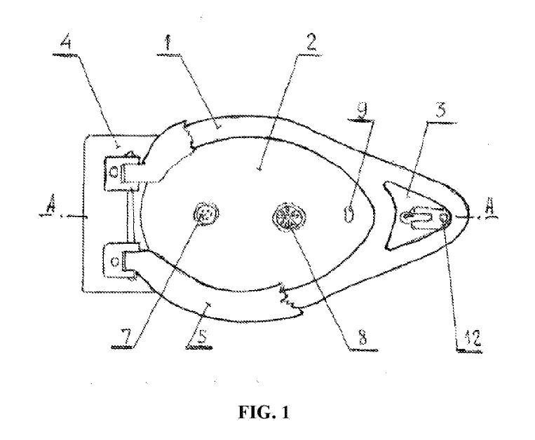

FIG. 1 shows a general top view of a jet bidet.

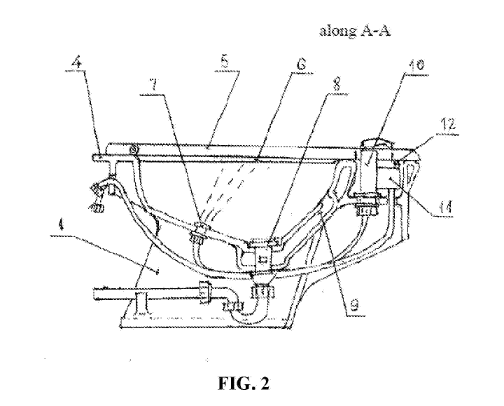

FIG. 2 shows a general cross-sectional view of a jet bidet with a tip-up seat pressed down.

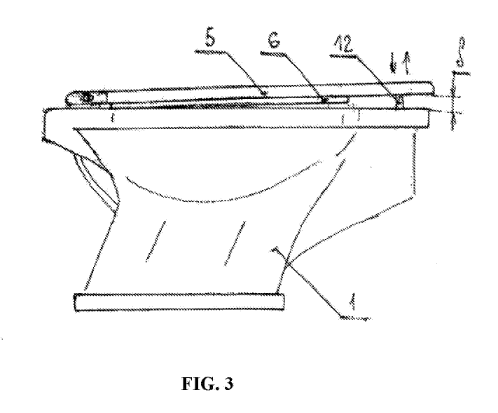

FIG. 3 shows a general side view of a jet bidet with a tip-up seat closed.

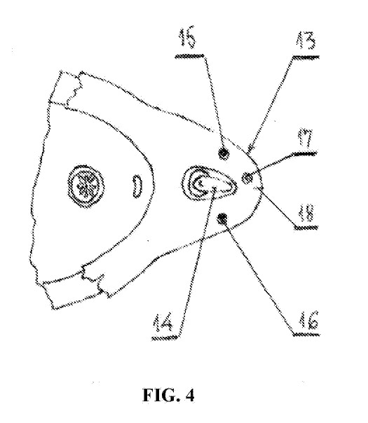

FIG. 4 shows an arrangement of mnemonic color symbols for mixer lever positions according to the temperature of water.

1. A jet bidet relating to objects of hygienic equipment of healthcare providers and for daily use by residents of buildings; made of ceramic materials according to known, standard manufacturing techniques of sanitary wares, connectable to a hot and cold water supply system, the jet bidet comprising a bidet body in the form of a bathtub with supporting-and-decorative elements configured to install the jet bidet on the floor or hang it on a wall, a nozzle which produces an upward vertical stream of water, a waste outlet in fluid communication with a trap device and a bathtub overflow protection device, a hot and cold water mixer, flexible connecting hoses, characterized in that the bidet body has two sections and comprises an integrated flat boss at the upper portion at the back thereof to which boss a tip-up seat is secured whereon a user may sit down, the tip-up seat covering all around both bidet body sections and being provided with an elastic seal which prevents water from entering under the seat, the bathtub being one of the sections of the body and being made with the shape and size of a standard toilet somewhat elongated to allow the passage of the band in front between the sitting user's legs and behind his/her back, the bathtub being equipped with a nozzle which produces an upward shower jet whose temperature and pressure are controlled quickly and effectively by the user himself/herself and which is configured with respect to the cross section of the entire jet and small jets it comprises, and is focused on a user's body part to be washed so as to ensure both comfortable and effective performance of a hygienic procedure without the assistance of hands, the bathtub being provided with a waste outlet at the bathtub bottom in fluid communication with a bathtub overflow protection device arranged at a front wall outside the bathtub; a control compartment being the second section, the control compartment having the shape of an isosceles triangle with a rounded apex whose base is adjacent integrally to the bathtub at the front thereof, the control compartment being between the knees of the user, who sits on the bathtub, the control compartment being provided with a cold and hot water lever mixer whose outlet is interlocked with a closure device which is controlled by a pressure-action plunger, which is arranged under an edge of the tip-up seat being lowered and turns the nozzle on when the user sits down on the seat and turns the nozzle off when the user gets up off the seat; the nozzle may also be turned on by pressing the plunger by hand (the jet pressure is to be adjusted beforehand) to fill the bathtub whenever necessary, mnemonic color symbols being applied to a rounded portion of the seat, which covers the control compartment, said symbols indicating the extreme positions of the mixer lever—the cold water position and the hot water position, as well as the intermediate warm water position for a comfortable beginning of the procedure.
